(19) United States
(12) Patent Application Publication
(10) Pub. No.: US 2025/0021678 A1
(43) Pub. Date: Jan. 16, 2025

(54) SCALABLE DATA OBFUSCATION FOR DIFFERENT IDENTIFIER TYPES

(71) Applicant: International Business Machines Corporation, Armonk, NY (US)

(72) Inventors: Mario Dominic Savio Briggs, Bangalore (IN); Mithun Virajpet Brahmappa, Bengaluru (IN); Natesh H. Mariyappa, Bengaluru (IN); Seema Narayan Bhat, Bengaluru (IN)

(73) Assignee: International Business Machines Corporation, Armonk, NY (US)

(21) Appl. No.: 18/222,297

(22) Filed: Jul. 14, 2023

(51) Int. Cl. G06F 21/62

(52) U.S. Cl. CPC G06F 21/6218

(57) ABSTRACT

A computer-implemented method, according to one embodiment, includes: receiving a request to mask an input value, and in response to receiving the request, determining a domain size of the input value. A rank score of the input value is also determined. The domain size and the rank score are used to generate a unique value correlated with the input value. Moreover, the unique value is unranked by converting characters of the unique value to create a masked string value. The input value is then replaced with the masked string value.

### BACKGROUND

The present invention relates to data privacy, and more specifically, this invention relates to implementing data obfuscation in distributed data environments.

As computing power continues to advance and the use of IoT devices becomes more prevalent, the amount of data produced continues to increase. For instance, the rise of smart enterprise endpoints has led to large amounts of data being generated at remote locations. Data production will only further increase with the growth of 5G networks and an increased number of connected mobile devices. This issue has also become more prevalent as the complexity of machine learning models increases.

Data privacy regulations have also been implemented in an attempt to secure the process of storing and processing this influx of data. Data obfuscation has been used in some situations to conceal details of important information to reduce the risk of data compromise. For example, obfuscation of personally identifiable information is used to prevent sensitive data from being exposed.

However, conventional systems have experienced drawbacks resulting from attempts to implement this obfuscation. For instance, conventional systems have relied on operating deterministic finite state machines each time data is masked. However, this introduces a notable amount of latency and compute overhead. Additionally, the number of unique sequences does not have a fixed limit, thereby causing conventional systems to also experience broken applications resulting from data unavailability.

Other previous attempts have involved storing character patterns used to generate the deterministic finite state machines in cache. While this avoids the process of generating deterministic finite state machines in some situations, memory constraints prevent the growing number of unique sequences from being represented. This, in combination with data quality issues experienced in use, has thereby limited data obfuscation from being implemented at scale with large amounts of data without experiencing significant performance based drawbacks.

### SUMMARY

A computer-implemented method, according to one embodiment, includes: receiving a request to mask an input value, and in response to receiving the request, determining a domain size of the input value. A rank score of the input value is also determined. The domain size and the rank score are used to generate a unique value correlated with the input value. Moreover, the unique value is unranked by converting characters of the unique value to create a masked string value. The input value is then replaced with the masked string value.

A computer program product, according to another embodiment, includes a computer readable storage medium having program instructions embodied therewith. The program instructions are readable by a processor, executable by the processor, or readable and executable by the processor, to cause the processor to: perform the foregoing method.

A system, according to yet another embodiment, includes: a processor, and logic that is integrated with the processor, executable by the processor, or integrated with and executable by the processor. Moreover, the logic is configured to: perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment.

FIG. 2 is a diagram of a distributed data storage and processing system, in accordance with one embodiment.

FIG. 3A is a flowchart of a method, in accordance with one embodiment.

FIG. 3B is a flowchart of sub-operations for performing an operation of FIG. 3A, in accordance with one embodiment.

FIG. 3C is a flowchart of sub-operations for performing an operation of FIG. 3A, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products implementing data obfuscation in distributed data environments. Implementations described herein are able to improve performance in a number of ways by obfuscating data much more efficiently than conventionally achievable. Again, implementations herein are able to avoid the use of deterministic finite state machines, thereby allowing for dynamic data masking to be implemented without experiencing significant latency and/or computational overhead, e.g., as will be described in further detail below.

In one general embodiment, a computer-implemented method includes: receiving a request to mask an input value, and in response to receiving the request, determining a domain size of the input value. A rank score of the input value is also determined. The domain size and the rank score are used to generate a unique value correlated with the input value. Moreover, the unique value is unranked by converting characters of the unique value to create a masked string value. The input value is then replaced with the masked string value.

In another general embodiment, a computer program product includes a computer readable storage medium having program instructions embodied therewith. The program instructions are readable by a processor, executable by the processor, or readable and executable by the processor, to cause the processor to: perform the foregoing method.

In yet another general embodiment, a system includes: a processor, and logic that is integrated with the processor, executable by the processor, or integrated with and executable by the processor. Moreover, the logic is configured to: perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved data masking code at block 150 for masking data while preserving a format of the data being masked, by dynamically generating a unique pattern of a same form. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

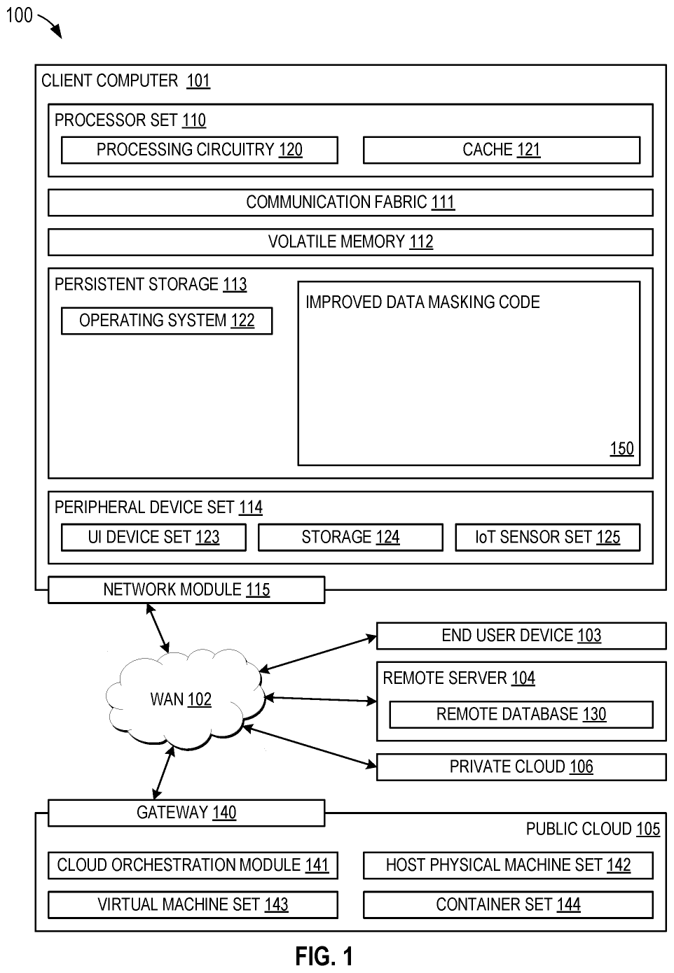

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some respects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As noted above, the amount of data produced continues to increase as computing power continues to advance and the use of IoT devices becomes more prevalent. The advancement of increasingly complex machine learning models also translates to more intense workloads and increased strain associated with applying the models to received data.

Data privacy regulations have also been implemented in an attempt to secure the process of storing and processing this influx of data. Obfuscation has been used in some situations to conceal details of important information in an attempt to reduce the risk of compromise. For example, obfuscation of personally identifiable information is used to prevent sensitive data from being exposed.

However, conventional systems have experienced drawbacks resulting from attempts to implement this obfuscation. For instance, conventional systems have relied on operating deterministic finite state machines each time data is masked. However, this introduces a notable amount of latency and compute overhead. Additionally, the number of unique sequences does not have a fixed limit, thereby causing conventional systems to also experience broken applications resulting from data unavailability.

Other previous attempts have involved storing character patterns used to generate the deterministic finite state machines in cache. While this avoids the process of generating deterministic finite state machines in some situations, memory constraints prevent the growing number of unique sequences from being represented. This, in combination with data quality issues experienced in use, has thereby limited data obfuscation from being implemented at scale with large amounts of data without experiencing significant performance based drawbacks.

The achievable throughput of conventional systems has thereby been limited and prevented data obfuscation from being implemented at scale with large amounts of data without experiencing significant performance based drawbacks. This is particularly true in situations involving dynamic data masking, where data is re-masked following each access.

In sharp contrast to these conventional shortcomings, implementations herein are desirably able improve performance by notably reducing strain placed on compute components. For instance, masked values that are produced by implementations herein are preferably aggregated such that the resulting string of masked values has a same order as the initially received input value. This allows for the resulting masked string value to have a same format as the input value. Implementations herein may thereby be applied to input values of various types without having to implement a different software layer to accommodate a change in format caused by the masking process. This also preserves format and consistency across non-reversible and reversible obfuscations without using deterministic finite state machines.

As a result, implementations herein are able to obfuscate data much more efficiently than conventionally achievable. Again, implementations herein are able to avoid the use of deterministic finite state machines, thereby allowing for dynamic data masking to be implemented without experiencing significant latency and/or computational overhead. While operational shortcomings are common in conventional systems, approaches herein are again able to reduce the number of computational processes that are performed in order to mask incoming data by avoiding the use of deterministic finite state machines, e.g., as will be described in further detail below.

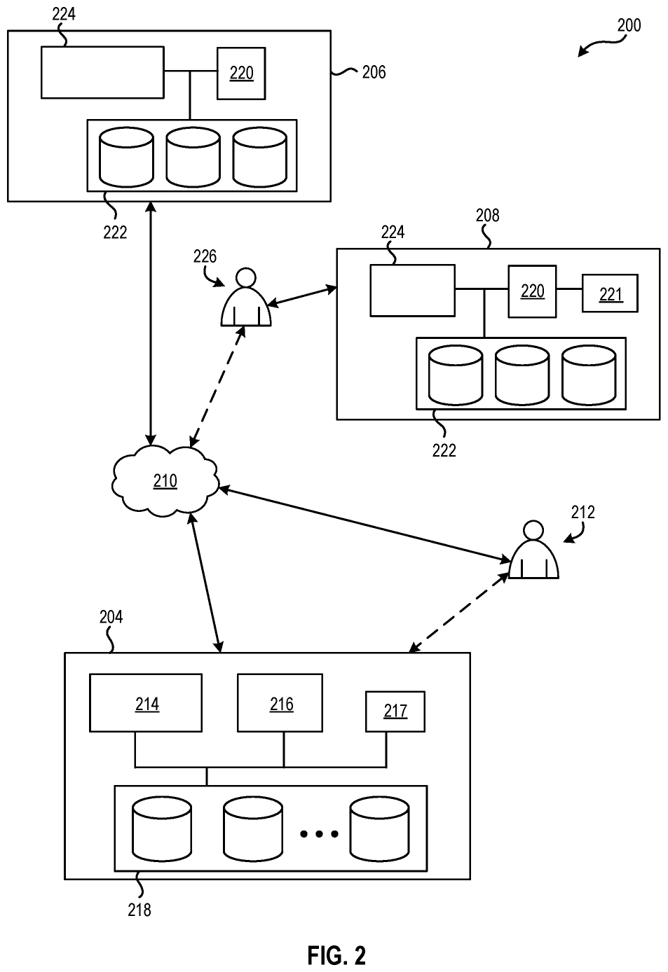

Looking now to FIG. 2, a distributed data storage and processing system 200 is shown in accordance with one embodiment. As an option, the present system 200 may be implemented in conjunction with features from any other embodiment listed herein, such as those described with reference to the other FIGS., such as FIG. 1. However, this system 200 and others presented herein may be used in various applications and/or in permutations which may or may not be specifically described in the illustrative embodiments listed herein. Further, the system 200 presented herein may be used in any desired environment. Thus FIG. 2 (and the other FIGS.) may be deemed to include any possible permutation.

As shown, a central data storage location 204 (e.g., central server) is connected to remote user locations 206, 208 over network 210. An administrator 212 of the central data storage location 204 is also shown as being connected to network 210. In some implementations, the administrator 212 may be directly connected to the central data storage location 204 as represented by the dashed arrowed line. It follows that the administrator 212 may be able to control at least a portion of the central data storage location 204, e.g., updating software being run by a central processor 214.

It should also be noted that “connected” and “communicate” as used herein are intended to refer to any desired type of connection between two points that allows for the exchange of information therebetween. In other words, data, instructions, commands, responses, user inputs, etc. may be sent between any two or more locations (components) that are configured to communicate with each other as a result of being directly and/or indirectly connected to each other, e.g., as would be appreciated by one skilled in the art after reading the present description.

For instance, the network 210 indirectly connects each of the central data storage location 204 and the user locations 206, 208. Depending on the approach, the network 210 may be of any type. For instance, in some approaches the network 210 is a WAN, e.g., such as the Internet. However, an illustrative list of other network types which network 210 may implement includes, but is not limited to, a LAN, a PSTN, a SAN, an internal telephone network, etc. Accordingly, the central data storage location 204 and the user locations 206, 208 are able to communicate with each other regardless of the amount of separation which exists therebetween, e.g., despite being positioned at different geographical locations.

The central data storage location 204 includes a central processor 214. In some approaches, the central processor 214 includes a large (e.g., robust) controller that is coupled to a cache 216 and a data storage array 218 having a relatively high storage capacity. The central data storage location 204 is thereby able to process and store a relatively large amount of data, allowing it to be connected to, and communicate with, multiple different remote locations. As noted above, the central data storage location 204 may receive data, commands, etc. from any number of user locations (e.g., remote servers). The components included in the central data storage location 204 thereby preferably have a higher achievable throughput than components included in each of the user locations 206, 208, to accommodate the higher flow of data experienced at the central data storage location 204.

It should be noted that with respect to the present description, “data” may include any desired type of information. For instance, data may include one or more data blocks, each of which includes about the same amount of data. These data blocks may thereby serve as logical partitions between subsets of data, e.g., as would be appreciated by one skilled in the art after reading the present description. In different implementations data can include raw sensor data, metadata, program commands, instructions, etc. It follows that the processor 214 may use the cache 216 and/or storage array 218 to cause one or more data operations to be performed. According to an example, the processor 214 at the central data storage location 204 may cause one or more data write operations to be performed in memory at the storage array 218.

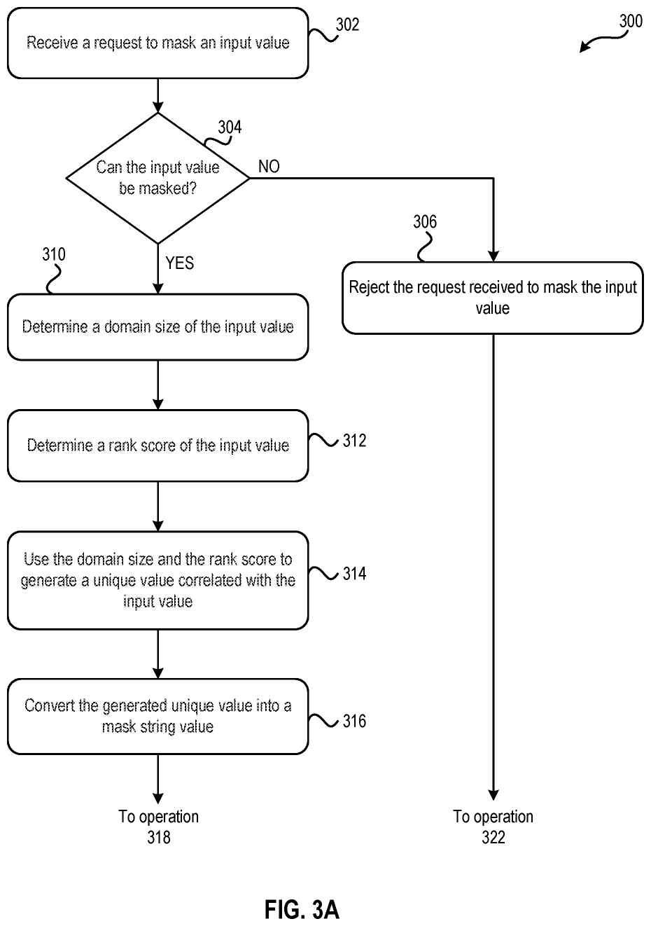

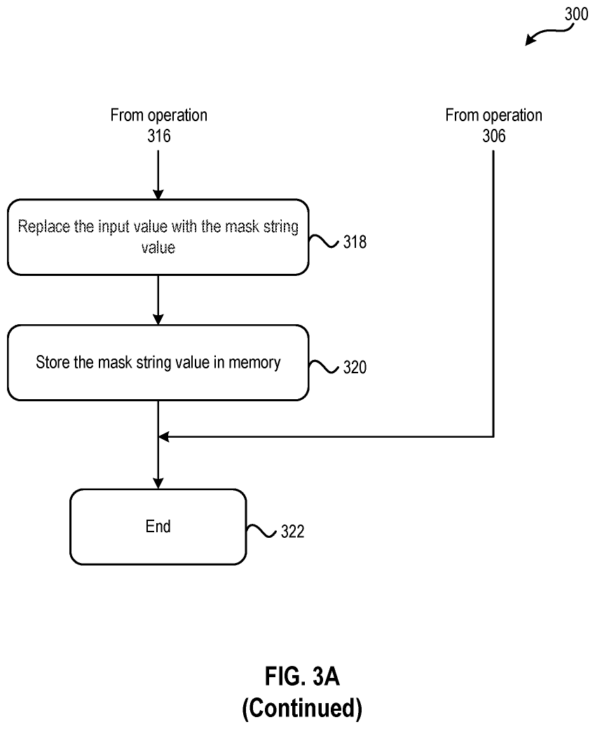

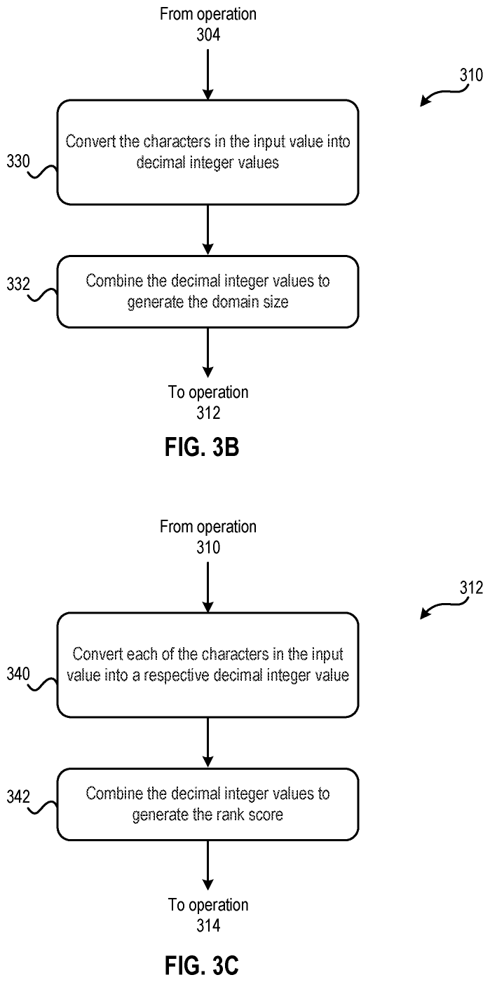

The central data storage location 204 even includes a dynamic data masking module 217 in some implementations. The dynamic data masking module 217 may be configured to identify data that is not currently obfuscated. In response to detecting data that has not yet been masked, the dynamic data masking modules 217 may thereby be able to modify how the data is represented, such that the content is protected from undesired access. While the dynamic data masking module 217 is shown as a standalone component in the present depiction, in other implementations the functionality of a data masking module may be implemented as software that runs on the central processor 214. It follows that the dynamic data masking module 217 may be used to perform one or more of the operations that are shown below in method 300 of FIG. 3A.

With continued reference to FIG. 2, each of the user locations 206, 208 include a processor 220 coupled to memory 222 as well as cache 224. While the user locations 206, 208 are depicted as including similar components and/or construction, it should be noted that any desired components may be implemented in any desired arrangement. In some instances, each remote user location in a system may be configured differently to provide each location with a different ability.

For example, another dynamic data masking module 221 is shown as being located at user location 208. The dynamic data masking module 221 may also be able to obfuscate data at the user location 208, e.g., before it is sent to central data storage location 204 over network 210. The dynamic data masking module 221 at user location 208 may be configured similarly or the same as dynamic data masking module 217 in some approaches. In others, the two dynamic data masking modules 221, 217 may be configured differently. For example, each of the dynamic data masking modules 221, 217 may be configured to mask the data differently, e.g., depending on a desired level of obfuscation, based on past data exposures, in response to predetermined conditions being met, in response to receiving input from a user, etc.

It should also be noted that the dynamic data masking modules 221, 217 are preferably able to mask data of any desired type and/or size. As noted above, while conventional systems have been unable to process data dynamically as a result of the latency and processing overhead experienced with each masking performance, implementations herein overcome this limitation. Thus, the dynamic data masking modules 221, 217 are desirably able to dynamically mask large amounts of data as the data is accessed and/or received in real-time.

Again, while dynamic data masking module 221 is shown as a standalone component in the present depiction, in other implementations the data masking module may be implemented as software that runs on the processor 220 in some implementations. It follows that the dynamic data masking modules 221 may be used to perform one or more of the operations that are shown below in method 300 of FIG. 3A.

Different locations (e.g., servers) in system 200 may thereby have different performance capabilities. As noted above, the central data storage location 204 may have a higher achievable throughput compared to the user locations 206, 208. While this may allow the central data storage location 204 the ability to perform more data operations in a given amount of time than the user locations 206, 208, other factors impact achievable performance. For example, traffic over network 210 may limit the amount of data that may be sent between the different locations 204, 206, 208. The workload experienced at a given time also impacts latency and limits achievable performance.

A user 226 is also connected to user location 208. In some approaches, the user 226 connects to the user location 208 through a compute device (e.g., such as the user's personal computer, mobile phone, etc.) such that information can be exchanged therebetween. However, in other approaches the user 226 may be able to access the user location 208 using one or more terminals having a user interface. The user 226 may also be connected to the network 210 in some implementations. Accordingly, the user 226 may access user location 208 and/or other locations in system 200 through the network 210 in such implementations. In still other implementations, the user may be able to access network 210 by using a direct connection to the user location 208, e.g., as would be appreciated by one skilled in the art after reading the present description.

It follows that user locations 206, 208 are able to receive data from the central data storage location 204 and even modify the data that is received. For example, data received from the central data storage location may be stored in the cache 224. Accordingly, data received from the central data storage location may be processed (e.g., modified) by a user as desired. Similarly, data received at one of the user locations 206, 208 may be processed and masked before being stored in memory 222 and/or sent over network 210.

The cache 224, processor 220, and dynamic data masking module 221 may thereby provide compute resources that can be used to perform requests received from users (e.g., see user 226) as well as data processing applications, machine learning models for evaluating data received, or other types of software, e.g., as would be appreciated by one skilled in the art after reading the present description. Moreover, by implementing operations in method 300 below, data that is stored and/or received at a location in system 200 can be seamlessly obfuscated while reducing impact on the system.

Referring now to FIG. 3A, a flowchart of a method 300 for masking data while preserving a format of the data by dynamically generating a pattern is shown according to one embodiment. The method 300 may be performed in accordance with the present invention in any of the environments depicted in FIGS. 1-2, among others, in various embodiments. Of course, more or less operations than those specifically described in FIG. 3A may be included in method 300, as would be understood by one of skill in the art upon reading the present descriptions.

Each of the steps of the method 300 may be performed by any suitable component of the operating environment. For example, one or more of the operations in method 300 may be performed at a user location (e.g., see user location 206 of FIG. 2 above) in some embodiments. In another embodiment, one or more of the operations in method 300 may be performed at a central data vault (e.g., see central data storage location 204 of FIG. 2 above). In various other embodiments, the method 300 may be partially or entirely performed by a controller, a processor, a computer, etc., or some other device having one or more processors therein. Thus, in some embodiments, method 300 may be a computer-implemented method. Moreover, the terms computer, processor and controller may be used interchangeably with regards to any of the embodiments herein, such components being considered equivalents in the many various permutations of the present invention.

Moreover, for those embodiments having a processor, the processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 3A, operation 302 of method 300 includes receiving a request to mask one or more input values. With respect to the present description, an “input value” may include any input that is used to convey information. For example, different types of data identifiers may be received as input values. Different types of data identifiers may have a variety of different formats. Some identifiers are made up of publicly defined and exclusive ranges (e.g., sub-patterns or formats) which may be more easily identifiable. Other identifiers are not public and may be specific to an organization, thereby varying in format, size, etc. It follows that public and/or private input values may be received in operation 302.

In some approaches, the input value itself is received along with the request. Accordingly, operation 302 may include receiving the input value in addition to the request to mask the input value. The request may be received at a user location, a central data vault, etc., depending on the approach. It follows that the request may also be received from a number of different locations, e.g., such as an application running at a remote data storage location, directly from a user, etc.

It follows that the request may involve masking an input value in real-time. In other words, the request received in operation 302 may involve dynamically obfuscating information as the requests and/or input values are received.

From operation 302, method 300 proceeds to operation 304. There, operation 304 includes determining whether the input value can be masked. While the request received in operation 302 may request a particular input value be masked, the request is not always fulfilled. In some approaches, a request to mask a particular input may contradict predetermined settings, specific user instructions, data storage security protocols, etc. In other approaches, certain input values may be more difficult to mask. In still other approaches, an input value may be inspected to determine whether the value has already been masked, or whether a sufficient amount of processing bandwidth is currently available to attempt obfuscating the input value.

Operation 304 involves inspecting the input value to make this determination. Moreover, the input value may be compared against past masking operations, current system characteristics (e.g., available computing overhead, network bandwidth, etc.), etc. In response to determining that the input value cannot be masked, method 300 proceeds to operation 306. In other words, the flowchart advances from operation 304 to operation 306 in response to determining that data obfuscation cannot be performed in the present instance.

There, operation 306 includes rejecting the request received in operation 302. In some approaches, a warning is returned to the entity (e.g., application, processing component, user, etc.) that originally issued the request. The warning preferably indicates that the masking request was not successfully accomplished and may even request an input for a backup procedure. In other words, the warning may inform a user of the failed obfuscation and request feedback on how the input value originally referenced in operation 302 should be handled.

From operation 306, the flowchart of FIG. 3A proceeds to operation 322, whereby method 300 may end. However, it should be noted that although method 300 may end upon reaching operation 322, any one or more of the operations included in method 300 may be repeated in order to mask additional information. In other words, any one or more of the operations included in method 300 may be repeated for subsequently received input masking requests.

Returning to operation 304, method 300 proceeds to operation 310 in response to determining that the input value can be masked. In other words, the flowchart advances from operation 304 to operation 310 in response to receiving the request and determining that data obfuscation can be performed in the present instance.

There, operation 310 includes determining a domain size of the input value. The domain size of the input value is preferably based at least in part on the cardinality of each respective character in the input value. In other words, the domain size is determined in some approaches using the number of possible values that each character in the input value may have. For example, the cardinality of a single-digit numerical character (number) in the input value is 10, while the cardinality of a single English-based character (letter) is 26.

Referring momentarily to FIG. 3B, exemplary sub-operations of determining the domain size of an input value are illustrated in accordance with one embodiment. One or more of these sub-operations may be used to perform operation 310 of FIG. 3A. However, it should be noted that the sub-operations of FIG. 3B are illustrated in accordance with one embodiment which is in no way intended to limit the invention.

As shown, determining the domain size of an input value includes converting the characters in the input value into decimal integer values. See sub-operation 330. In other words, sub-operation 330 includes converting each character in the input value into a numerical value. Thus, while it is preferred that the resulting masked value has a same format (e.g., length, order of character types, etc.) as the input value received, converting the characters in the input value into a respective decimal integer value allows for additional processing to be performed. For instance, a determination can be made as to the size of the domain associated with the input value received.

As noted above, the domain size of the input value is based at least in part on the cardinality of each respective character in the input value. Accordingly, the cardinality of a respective character in the input value may be used to convert the character into a numerical value. In other words, the domain size is determined in some approaches using the number of possible values that each character in the input value may have.

In response to converting each character in the input value in sub-operation 330, the flowchart proceeds to sub-operation 332. There, sub-operation 332 includes combining the decimal integer values to generate the domain size. It should also be noted that in preferred approaches, a “decimal integer value” may include any of the whole numbers, 0 through 9. Accordingly, each single-digit number determined as representing a respective character in the input value are merged to produce the domain size.

The decimal integer values may be combined differently depending on the desired implementation. For instance, in different implementations the decimal integer values may be averaged, summed, multiplied, etc. According to an in-use example, which is in no way intended to limit the invention, the domain size may be determined using Equation 1 below.

$$Domain\_Size = {X}_{1}^{{Y}_{1}} * {X}_{2}^{{Y}_{2}} * … {X}_{N}^{{Y}_{N}} \qquad Equation 1$$

As seen, Equation 1 calculates the domain size by determining the product of a number of values that correspond to the “N” different characters included in the input value. Specifically, the value of “X” corresponds to the cardinality of the respective type of character in the input value. The value of “Y” further corresponds to the number of times the respective type of character appears in the input value.

According to an example, which is in no way intended to limit the invention, the domain size of the input value UG8T6 would be determined as represented in Equation 2.

$$Domain\_Size = {26}^{3} * {10}^{2} \qquad Equation 2$$

As shown in Equation 2, the value of 26 represents that a first type of character in the input value is a letter of the English language, having 26 different possible values (i.e., a cardinality of 26). Moreover, 26 is shown as raised to the power of 3, indicating there were 3 total letters of the English language in the full input value of UG8T6. The value of 10 represents that a second type of character in the input value is a single-digit number, having 10 different possible values. The value of 10 is further shown to the power of 2, representing that 2 different single-digit numbers appear in the full input value of UG8T6.

In response to determining (e.g., generating) the domain size in sub-operation 332, FIG. 3B is shown as advancing to operation 312 of method 300. Accordingly, looking back now to FIG. 3A, the domain size determined in operation 310 is used further in the process of masking the input value received. In other words, the output of operation 310 may be at least temporarily stored in memory and accessed in order to determine a unique value correlated with the input value and/or a masked string value that replaces the input value, e.g., as will be described in further detail below.

Proceeding to operation 312, there method 300 includes determining a rank score of the input value. The rank score of the input value is preferably based at least in part on the cardinality of each respective character in the input value. In other words, the rank score is determined in some approaches using the number of possible values that each character in the input value may have.

Referring momentarily to FIG. 3C, exemplary sub-operations of determining the rank score of an input value are illustrated in accordance with one embodiment. One or more of these sub-operations may be used to perform operation 312 of FIG. 3A. However, it should be noted that the sub-operations of FIG. 3C are illustrated in accordance with one embodiment which is in no way intended to limit the invention.

As shown, determining the rank score of an input value includes converting each of the characters in the input value into a respective decimal integer value. See sub-operation 340. In other words, sub-operation 340 includes converting each character in the input value into a numerical value. Again, while it is preferred that the resulting masked value has a same format (e.g., length, order of character types, etc.) as the input value received, converting the characters in the input value into a respective decimal integer value allows for additional processing to be performed. For instance, a determination can be made as to the characteristics associated with the input value received.

As noted above, the rank score of the input value is based at least in part on the cardinality of each respective character in the input value. Accordingly, the cardinality of a respective character in the input value may be used to convert the character into a numerical value. In other words, the rank score is determined in some approaches using the number of possible values that each character in the input value may have.

In response to converting each character in the input value in sub-operation 340, the flowchart proceeds to sub-operation 342. There, sub-operation 342 includes combining the decimal integer values to generate the rank score. It should again be noted that in preferred approaches, a “decimal integer value” may include any of the whole numbers, 0 through 9. Accordingly, each single-digit number determined as representing a respective character in the input value are merged to produce the rank score.

The decimal integer values may be combined differently to produce the rank score depending on the desired implementation. For instance, in different implementations the decimal integer values may be averaged, summed, multiplied, etc. According to an in-use example, which is in no way intended to limit the invention, the rank score may be determined using Equation 3 below.

$$Rank\_Score = {\sum }_{B = 1}^{B = N} {A}_{B} * C \qquad Equation 3$$

As seen, Equation 3 calculates the rank score by determining the sum of a number of values that correspond to the “N” different characters “B” included in the input value. Specifically, the variable “A” corresponds to the position of the character in the respective cardinality, while “C” represents the product of the cardinality of all prior characters in the input value.

According to an example, which is in no way intended to limit the invention, the rank score for an input value of AS8M7 may be determined as follows. As noted above, a numerical value may be determined (e.g., calculated) for each of the characters in the AS8M7 input value. It is also preferred that the characters in the input value are evaluated in a direction moving right-to-left. Accordingly, the evaluation process is able to assess the input value beginning at a least significant bit, and working towards a most significant bit.

Referring still to the present in-use example, it follows that the right-most character in the input value is a “7”. The number 7 is the 7^{th} possible value for a single-digit numerical variable, making A₁=7. Moreover, no prior characters have been evaluated yet, thereby making C=1. The numerical value that corresponds to the right-most value in the input value of AS8M7 is thereby determined by multiplying these values together, arriving at a value of 7.

The next right-most character in the input value is an “M”. The letter M is the 12^{th} possible value for a single English letter, making A₁=12. Moreover, the prior character was a single-digit number having a cardinality of 10, thereby making C=10. The numerical value that corresponds to the numerical value of “M” of the input value of AS8M7 can thereby be determined by multiplying these values of A₁ and C together, arriving at a value of 120.

The next right-most character in the input value is an “8”. The number 8 is the 8^{th} possible value for a single-digit number, making A₁=8. Moreover, the prior characters include a single-digit number having a cardinality of 10, as well as a single English letter having a cardinality of 26, thereby making C=10*26. The numerical value that corresponds to the numerical value of “8” of the input value of AS8M7 can thereby be determined by multiplying these values of A₁ and C together, arriving at a value of 2080.

Following similar schemes, the numerical value of “S” of the input value AS8M7 can be calculated as 46800, while the numerical value of “A” of input value AS8M7 is calculated as 0 since “A” is the first possible value for a single English letter. Further still, the rank score may be determined by adding each of the numerical values generated for the various characters of the input value. Following the present in-use example, the rank score may thereby be determined by calculating the sum of 7, 120, 2080, 46800, and 0 as described above, resulting in a rank score of 49007.

In response to determining (e.g., generating) the rank score in sub-operation 342, FIG. 3C is shown as advancing to operation 314 of method 300. Accordingly, looking back now to FIG. 3A, the rank score determined in operation 312 is used further in the process of masking the input value received. In other words, the output of operation 312 may be at least temporarily stored in memory and accessed in order to determine a unique value correlated with the input value and/or a masked string value that replaces the input value, e.g., as will be described in further detail below.

Proceeding to operation 314, there method 300 includes using the domain size and the rank score to generate a unique value correlated with the input value. In some approaches, using the domain size and the rank score to generate the unique value includes applying a format preserving encryption algorithm and/or a format preserving tokenization algorithm to the rank score. Applying one or both of these illustrative algorithms is able to generate a unique value that corresponds to the domain size and rank score described above.

According to one example, which is in no way intended to limit the invention, the domain size and the rank score may be used to generate a unique value for a corresponding input value by generating a secure hash value of the rank score. In other words, the domain size and/or rank score may be used to generate a secure hash value of the rank score. However, any desired type of format preserving algorithm may be used in combination with the rank score and/or domain size to generate a unique value for the input value. With respect to the present description, a “format preserving” algorithm refers to algorithms that produce an output which has a same form as an input provided to the algorithm. In other words, the format does not change. According to one example, an alphanumeric string of characters may be received as the input value. One or more algorithms may process the input value and/or other values to produce an alphanumeric string of characters having a same length and arrangement as the input value.

From operation 314, method 300 proceeds to operation 316. There, operation 316 includes unranking the unique value by converting characters of the unique value to create a masked string value. Operation 316 thereby includes converting each entry in the unique value generated in operation 314, into a string of obfuscated characters. Furthermore, the obfuscated characters are preferably aggregated to form a masked entry representing the originally received input value.

Each component of the unique value is selectively processed to convert the respective component into a form that corresponds to a matching portion of the input value originally received. In other words, each component (e.g., digit) of the unique value is converted into an entry, the entries collectively making up (e.g., resulting in) the masked string value. Moreover, each entry of the masked string value that is produced is a same type of character as a corresponding entry of the input value. As a result, the masked string value retains a same form as the input value originally received in operation 302. Again, it is preferred that a resulting masked value has a same format (e.g., length, order of character types, etc.) as the input value originally received.

In preferred approaches, the process of unranking a unique value includes applying an equation that incorporates the number of potential values each respective character in the input value can have to each character of the unique value to generate entries of the masked string value. In other words, unranking a unique value preferably involves incorporating the cardinality of each entry in the input value originally received.

The entries of the masked string value that are generated are also preferably aggregated in a predetermined order. For instance, masked values that are produced are preferably aggregated such that the resulting string of masked values has a same order as the initially received input value. This desirably allows for the resulting masked string value to have a same format as the input value. Implementations herein may thereby be applied to input values of various types without having to implement a different procedure to ensure the resulting masked string value is in a same form.

Moreover, this is true for different types of inputs. For example, some data formats include publicly well-defined and exclusive ranges or sub-patterns (also called “formats”) e.g., such as Social Security Numbers or telephone numbers in North America. However, other data formats are not public and can even be specific to different organizations. For example, customer identifications, account based information, etc., may have a unique format for each company, varying from one organization to another. Further each individual pattern might not be mutually exclusive in the total set of patterns in the domain. Examples of these custom identifiers include individual US state driver license numbers which have overlapping formats.

While conventional systems have struggled with processing different types of inputs, particularly with respect to forming masked copies, implementations herein are able to overcome these conventional issues. Again, implementations herein are able to obfuscate different types of data by forming a masked copy of the initial data. Moreover, the masked copy has the same format (e.g., length, arrangement of different character types, etc.) as the initial input. This allows for the masked copy of the initial data to be implemented in the same system as the initial value, without implementing various software layers to accommodate a change in format caused by the masking process. This mechanism allows for preserving format and consistency across non-reversible and reversible obfuscations.

For instance, a data obfuscation implemented on an alphanumeric input preferably results in another alphanumeric string, with each entry in the resulting alphanumeric string having a same format as a corresponding one of the entries in the input originally received. In other words, the resulting masked copy may include an alphanumeric string of values, where each letter has replaced a letter in the original input, and each digit has replaced a digit in the original input. The format of each entry of the input value originally received is thereby maintained in a masked version of that input value formed by implementations herein.

According to an in-use example, which is in no way intended to limit the invention, an input originally received for dynamic masking includes an alphanumeric string of characters having a pattern as follows: [A-Z][A-Z][0-9][A-Z][0-9]. Moreover, the unique value produced for the input originally received in the present in-use example is determined to be 201095. Based on this information, the masked string value can be determined by calculating the quotient of (i) a remainder, and (ii) a product of the cardinality of each remaining entry type in the masked string value.

Referring still to the present in-use example, the masked string value for the unique value of 201095 may be determined as follows. Initially, the “remainder” includes the whole unique value of 201095. Accordingly, the process of determining the first entry in the masked string value includes calculating the quotient of (i) 201095 and (ii) the product of the cardinality of each remaining entry type. As noted above, the resulting form of the masked string value preferably has the following pattern: [A-Z][A-Z][0-9][A-Z][0-9], again which matches the form of the input value being masked. The product of the cardinality of each entry type in this situation would thereby be calculated as 26×10×26×10 for the remaining 4 entries. The first entry is determined by calculating (201095/(26×10×26×10)) which results in a value of 2. Looking to the desired pattern of the resulting masked string value, the first entry (e.g., leftmost or most significant bit) is preferably an English letter. Accordingly, the value of 2 is translated into an alphabetical value of “C.”

Taking the updated remainder of 65895 from the quotient conducted above, the subsequent masked string value is again calculated as the quotient of (i) the remainder, and (ii) the product of the cardinality of each remaining entry type. Accordingly, the second entry of the masked string value is determined by calculating (65895/(10×26×10)) which results in a value of 25. Looking again to the desired pattern of the resulting masked string value, the second entry (e.g., next most significant bit) is preferably an English letter also. Accordingly, the value of 25 is translated into an alphabetical value of “Z.”

Taking the updated remainder of 895 from the quotient conducted above, the subsequent masked string value is again calculated as the quotient of (i) the remainder, and (ii) the product of the cardinality of each remaining entry type. Accordingly, the third entry of the masked string value is determined by calculating (895/(26×10)) which results in a value of 3. Looking once more to the desired pattern of the resulting masked string value, the third entry (e.g., next most significant bit) is preferably a single-digit number. Accordingly, the value of 3 is translated into a numerical value of “4.”

Furthermore, the fourth entry of the masked string value is determined by calculating (115/10) which results in a value of 11. Looking again to the desired pattern of the resulting masked string value, the fourth entry (e.g., next most significant bit) is preferably an English letter. Accordingly, the value of 11 is translated into an alphabetical value of “L.”

Finally, a remainder of 5 is left. Looking again to the desired pattern of the resulting masked string value, the fifth and final entry (e.g., least significant bit) is preferably a single-digit number. Accordingly, the value of 5 is translated into a numerical value of “6.”

As noted above, each of these determined values are further aggregated to form a resulting masked string of characters that represent the originally received input value, but in different form. According to the present in-use example, the resulting masked string of characters is “CZ3L5.” This obfuscates details of the input value received, thereby improving data security.

Referring back to FIG. 3A, method 300 proceeds to operation 318 in response to converting each entry in the unique value generated in operation 314, into a string of obfuscated characters. There, operation 318 includes replacing the input value with the masked string value, while operation 320 includes storing the masked string value in memory. In other approaches, the masked string value may be output to an entity (e.g., running application, obfuscation module, user, remote system, etc.) that issued the request originally received in operation 302 above. From operation 320, method 300 proceeds to operation 322 where method 300 may end, e.g., as described above.

Again, implementations herein are able to improve performance in a number of ways by notably reducing strain placed on compute components. For instance, masked values that are produced by implementations herein have a same format as the input value being masked. Implementations herein may thereby be applied to input values of various types without having to implement different software layers to accommodate a change in format caused by the masking process. This also preserves format and consistency across non-reversible and reversible obfuscations without using deterministic finite state machines.

As a result, implementations herein are able to obfuscate data much more efficiently than conventionally achievable. Again, implementations herein are able to avoid the use of deterministic finite state machines, thereby allowing for dynamic data masking to be implemented without experiencing significant latency and/or computational overhead. While operational shortcomings are common in conventional systems, approaches herein are again able to reduce the number of computational processes that are performed in order to mask incoming data by avoiding the use of deterministic finite state machines.

Certain aspects of the implementations described herein may further be improved as a result of implementing one or more machine learning models. These machine learning models may be trained to generate an order in which incoming data masking operations are performed. For instance, a machine learning model (e.g., a neural network) may be trained using labeled and/or unlabeled data corresponding to past performance of a data masking procedure implementing any of the processes described herein. Over time, the machine learning model may thereby be able to identify a preferred order in which data is masked. This understanding will allow the machine learning model to manage the masked values that have already been formed, and even determine an ideal order in which the masked values are ordered in order to best match the original input. In other words, the machine learning model may be trained over time to improve how well the format types of an initial value match the masked version. This improves data security while also reducing the impact on existing systems, e.g., as would be appreciated by one skilled in the art after reading the present description.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving a request to mask an input value;
in response to receiving the request, determining a domain size of the input value;
determining a rank score of the input value;
using the domain size and the rank score to generate a unique value correlated with the input value;
unranking the unique value by converting characters of the unique value to create a masked string value; and
replacing the input value with the masked string value.

2. The computer-implemented method of claim 1, wherein the domain size and the rank score are based at least in part on a number of potential values each character in the input value can have.

3. The computer-implemented method of claim 1, wherein determining the rank score of the input value includes:
converting each of the characters in the input value into a respective integer value; and
combining the integer values to determine the rank score.

4. The computer-implemented method of claim 1, wherein using the domain size and the rank score to generate the unique value includes:
applying a format preserving encryption algorithm, a format preserving tokenization algorithm, or a format preserving encryption algorithm and a format preserving tokenization algorithm, to the rank score to generate the unique value.

5. The computer-implemented method of claim 4, wherein the format preserving encryption algorithm and the format preserving tokenization algorithm use the domain size and the rank score.

6. The computer-implemented method of claim 1, wherein the masked string value includes a same format as the input value.

7. The computer-implemented method of claim 1, wherein determining the domain size of the input value includes:
converting the characters in the input value into integer values; and
combining the integer values to form the domain size.

8. The computer-implemented method of claim 1, wherein using the domain size and the rank score to generate the unique value includes generating a secure hash value of the rank score.

9. The computer-implemented method of claim 8, wherein unranking the unique value includes:
applying a number of potential values each character in the input value can have to each character of the unique value to generate entries of the masked string value; and
aggregating the entries in a predetermined order to form the masked string value.

10. A computer program product, comprising a computer readable storage medium having program instructions embodied therewith, the program instructions readable by a processor, executable by the processor, or readable and executable by the processor, to cause the processor to:
receive a request to mask an input value;
in response to receiving the request, determining a domain size of the input value;
determining a rank score of the input value;
using the domain size and the rank score to generate a unique value correlated with the input value;
unranking the unique value by converting characters of the unique value to create a masked string value; and
replacing the input value with the masked string value.

11. The computer program product of claim 10, wherein the domain size and the rank score are based at least in part on a number of potential values each character in the input value can have.

12. The computer program product of claim 10, wherein generating the rank score of the input value includes:
converting each of the characters in the input value into a respective integer value; and
combining the integer values to determine the rank score.

13. The computer program product of claim 10, wherein using the domain size and the rank score to generate the unique value includes:
applying a format preserving encryption algorithm, a format preserving tokenization algorithm, or a format preserving encryption algorithm and a format preserving tokenization algorithm, to the rank score to generate the unique value.

14. The computer program product of claim 13, wherein the format preserving encryption algorithm and the format preserving tokenization algorithm use the domain size and the rank score.

15. The computer program product of claim 10, wherein the masked string value includes a same format as the input value.

16. The computer program product of claim 10, wherein determining the domain size of the input value includes:
converting the characters in the input value into integer values; and
combining the integer values to form the domain size.

17. The computer program product of claim 10, wherein using the domain size and the rank score to determine the unique value includes generating a secure hash value of the rank score.

18. The computer program product of claim 17, wherein unranking the unique value includes:
applying a number of potential values each character in the input value can have to each character of the unique value to generate entries of the masked string value; and
aggregating the entries in a predetermined order to form the masked string value.

19. A system, comprising:
a processor; and
logic integrated with the processor, executable by the processor, or integrated with and executable by the processor, the logic being configured to:
receive a request to mask an input value;
in response to receiving the request, determining a domain size of the input value;
determining a rank score of the input value;
using the domain size and the rank score to generate a unique value correlated with the input value;
unranking the unique value by converting characters of the unique value to create a masked string value; and
replacing the input value with the masked string value.

20. The system of claim 19, wherein unranking the unique value includes:
applying a number of potential values each character in the input value can have to each character of the unique value to generate entries of the masked string value; and
aggregating the entries in a predetermined order to form the masked string value,
wherein the masked string value includes a same format as the input value.
